(19) United States
(12) Patent Application Publication
(10) Pub. No.: US 2016/0235083 A1
(43) Pub. Date: Aug. 18, 2016

(54) PRODUCING METHOD OF CIVET COFFEE BEANS

(71) Applicant: TENG-KO YANG, Taichung City (TW)

(72) Inventor: TENG-KO YANG, Taichung City (TW)

(21) Appl. No.: 14/684,322

(22) Filed: Apr. 10, 2015

(30) Foreign Application Priority Data
Feb. 16, 2015 (TW) 104105191

(51) Int. Cl. A23F 5/02

(52) U.S. Cl. CPC A23F 5/02

(57) ABSTRACT

A producing method of civet coffee including the steps of sampling step, separating step, assigning clans step, culturing step, husking step, mixing step and fermenting step. The coffee beans produced by the method after being ground and reconstituted, the caffeine contained therein is reduced and the harmful strains are disappeared. In addition, the life of the civet cats is continued. The selected cultured clan is sprinkled to the coffee kernels according to the thickness and the density of the coffee kernels such that all the coffee kernels are equally fermented. As a result, the coffee beans produced by the method accordance with the present invention have an unchangeable texture and aroma after being baked.

### BACKGROUND OF THE INVENTION

1. Field of the Invention

The present invention relates to producing method, and more particularly to a producing method of civet coffee beans.

2. Description of Related Art

As well known, drinking coffee can give oneself in a lift, improve the vermiculation of the intestinal tract, reduce the probability of getting Parkinson's disease, be helpful to urinate, restrain asthma, and so on. Consequently, the quantity of people, who drinks coffee, is gradually raised. In addition, the taste for coffee becomes high. In addition, more and more coffee beans with different classes are imported and some local farmers try to plant coffee tree. However, only the Indonesia civet coffee beans are praised without cease.

With reference to FIG. 1, the conventional method for producing civet coffee beans in accordance with the prior art is to feed the coffee drupes a to a civet cat and the civet cat washes down the coffee kernels b. The coffee beans c do not be digested in the gastrointestinal tract and directly excreted with the excreta. However, the coffee beans will be mixed with the secretion from the musk gland near the anus of the civet cat such that the civet coffee beans c have a special smell after being baked.

The civet cats are usually forced to eat a large number of coffee drupes. As a result, the civet cat is nearly extinct. Consequently, some coffee bean makers permeate the extract from the excreta of the civet cat in the place between the kernel d and the husk e of a coffee drupe for forming a ferment layer f to imitate civet coffee beans, as shown in FIG. 2.

However, the quantity and depth of permeation between the kernel d and the husk e of a coffee drupe is hard to be accurately controlled such that the texture and aroma of the conventional civet coffee bean are unstable.

The present invention has arisen to mitigate and/or obviate the disadvantages of the conventional producing methods of civet coffee beans.

### SUMMARY OF THE INVENTION

The main objective of the present invention is to provide an improved producing method of civet coffee beans, wherein the coffee beans produced by the method accordance with the present invention have an unchangeable texture and aroma after being baked.

To achieve the objective, the producing method in accordance with the present invention comprises the following steps:

step of sampling: the excrements from civet cats is sampled and collected in a vessel;

step of separating: the excrements in the vessel are separated for gaining probiotics, such as Microbacterium foliorum, Arthrobacter soli, Brevibacterium samyangense, Lysine bacillus parviboronicapien and Rhodococcus erythropolis;

step of assigning clans: the Microbacterium foliorum, Arthrobacter soli, Brevibacterium samyangense, Lysine bacillus parviboronicapien and Rhodococcus erythropolis are respectively identified by corresponding DNA sequence alignment and assigned to several clans; wherein the identified Microbacterium foliorum, Arthrobacter soli, Brevibacterium samyangense, Lysine bacillus parviboronicapien and Rhodococcus erythropolis are assigned to a first clan, the identified Microbacterium foliorum, Arthrobacter soli, Brevibacterium samyangense and Lysine bacillus parviboronicapien are assigned to a second clan, the identified Microbacterium foliorum, Arthrobacter soli, Brevibacterium samyangense and Rhodococcus erythropolis are assigned to a third clan, the identified Microbacterium foliorum, Arthrobacter soli, Lysine bacillus parviboronicapien and Rhodococcus erythropolis are assigned to a fourth clan, and the identified Microbacterium foliorum, Brevibacterium samyangense, Lysine bacillus parviboronicapien and Rhodococcus erythropolis are assigned to a fifth clan;

step of culturing: the clans are respectively cultured to form more clans according to the unique property thereof;

step of husking: the coffee beans are husked and the coffee kernels 81 are exploded;

step of mixing: a corresponding one of the cultured clans is selected and sprinkled to the coffee kernels according to the thickness and the density of the coffee kernels; and

step of fermenting: the coffee kernels coated with the selected clan are peripherally formed a clan coating such that the coffee kernels are transformed to civet coffee beans after being fermented.

Further benefits and advantages of the present invention will become apparent after a careful reading of the detailed description with appropriate reference to the accompanying drawings.

### BRIEF DESCRIPTION OF THE DRAWINGS

FIG. 1 is a cross-sectional view of a conventional coffee bean;

FIG. 2 is a cross-sectional of a conventional civet coffee bean;

FIG. 3 is a flow chart of a producing method of civet coffee beans in accordance with the present invention;

FIG. 4 a cross-sectional view of a civet coffee bean produced by the producing method in accordance with the present invention;

FIG. 5 is a schematic view of a first clan in accordance with the present invention;

FIG. 6 is a schematic view of a second clan in accordance with the present invention;

FIG. 7 is a schematic view of a third clan in accordance with the present invention;

FIG. 8 is a schematic view of a fourth clan in accordance with the present invention; and

FIG. 9 is a schematic view of a fifth clan in accordance with the present invention.

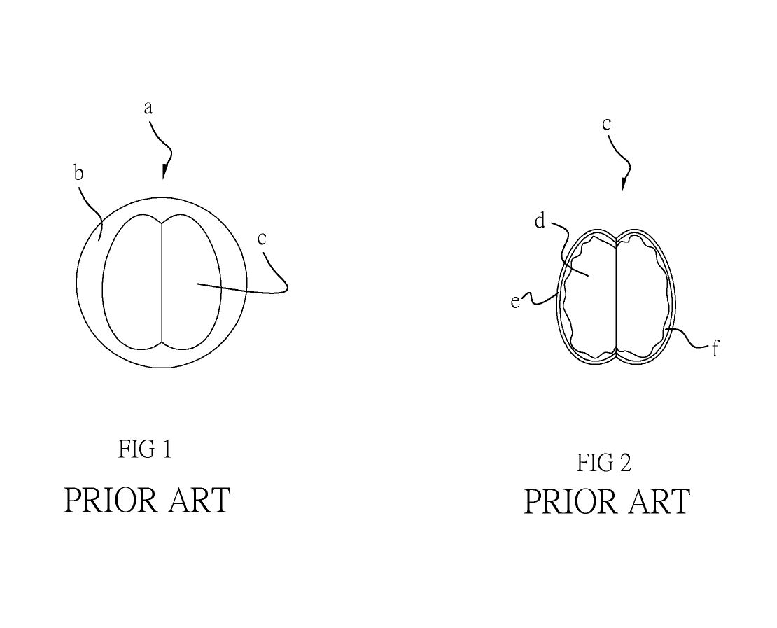

### DETAILED DESCRIPTION OF THE INVENTION

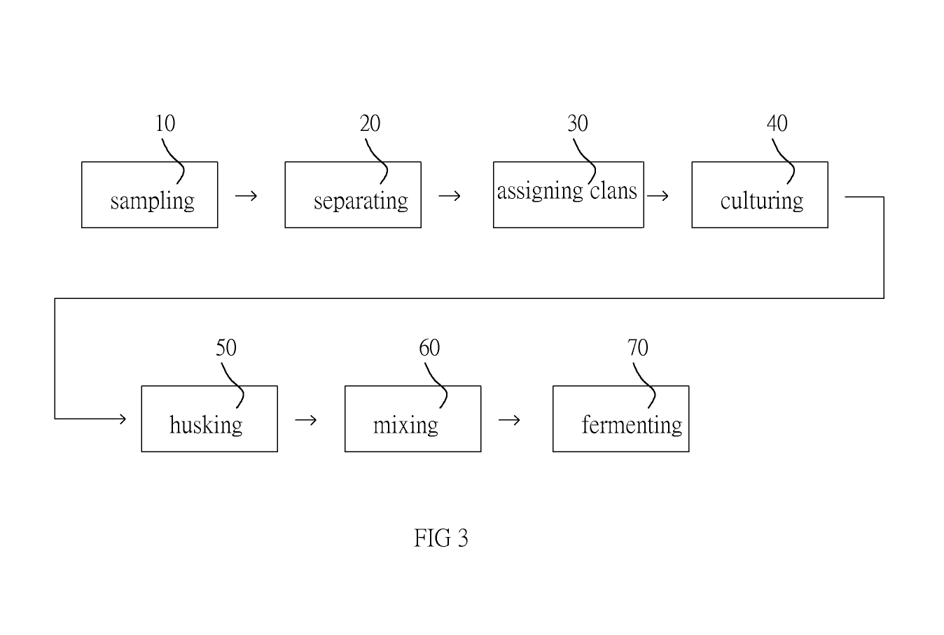

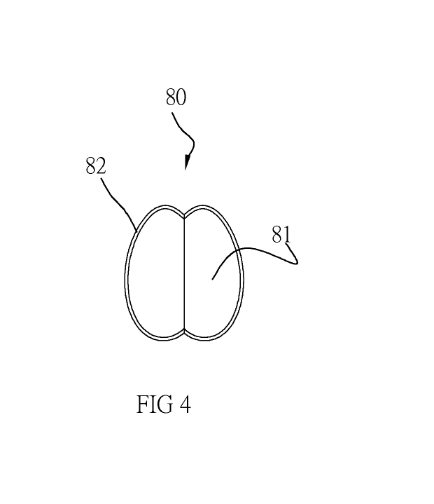

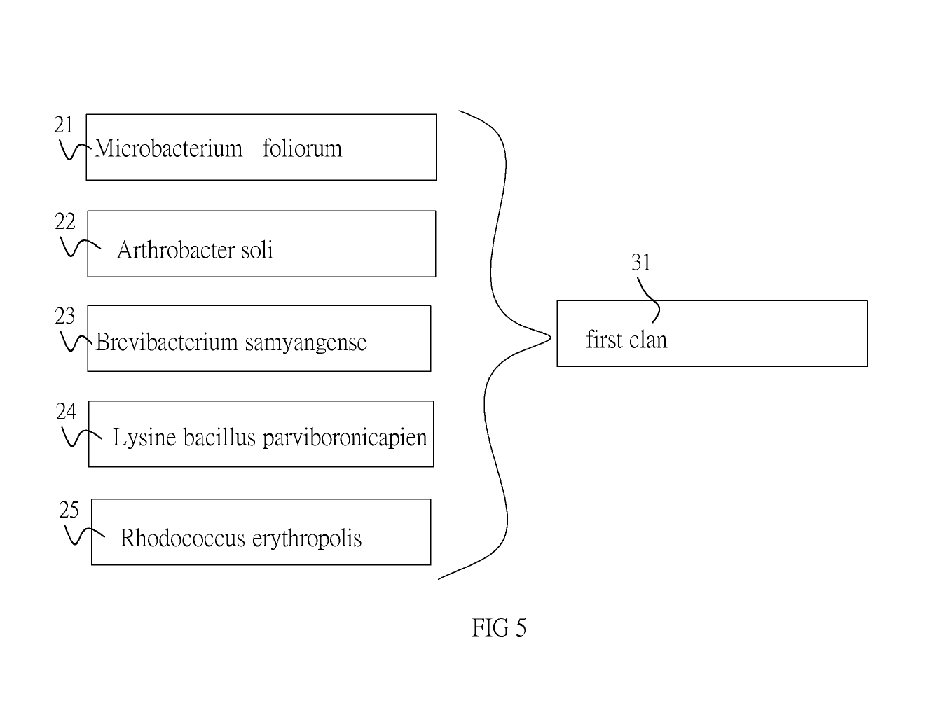

Referring to the drawings and initially to FIGS. 3-9, a producing method of civet coffee beans in accordance with the present invention comprises the following steps:

Step of sampling 10: the excrements from civet cats is sampled and collected in a vessel;

Step of separating 20: the excrements in the vessel are separated for gaining probiotics, such as Microbacterium foliorum 21, Arthrobacter soli 22, Brevibacterium samyangense 23, Lysine bacillus parviboronicapien 24 and Rhodococcus erythropolis 25.

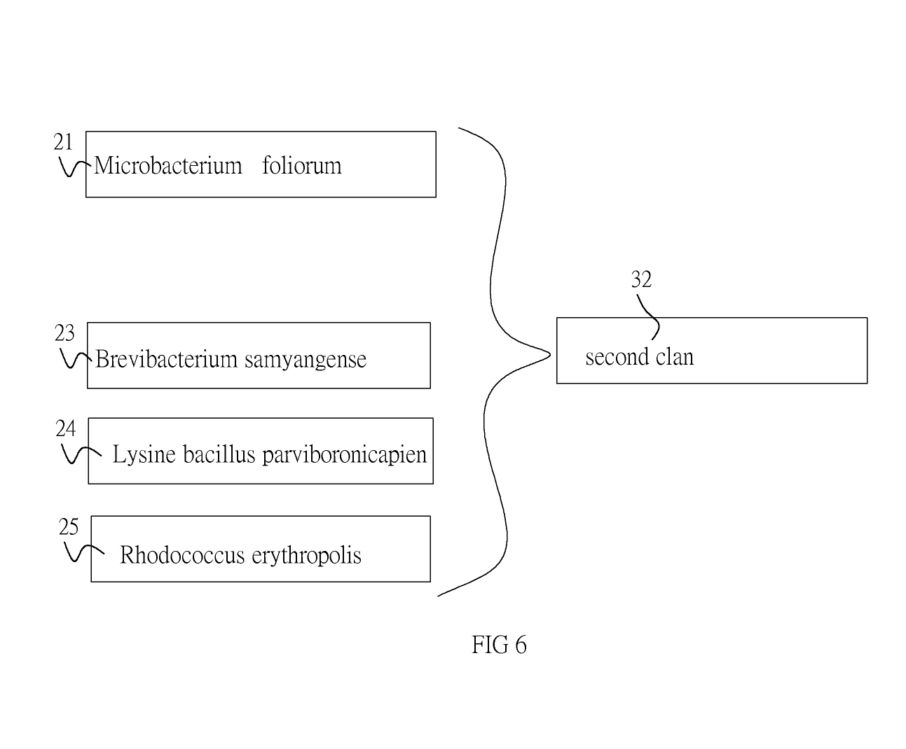

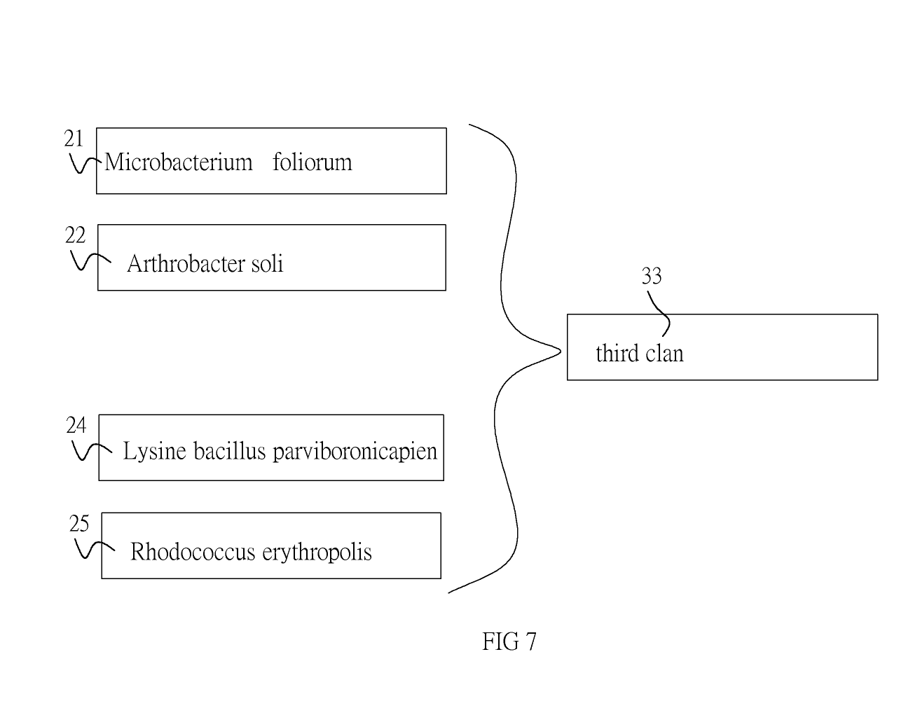

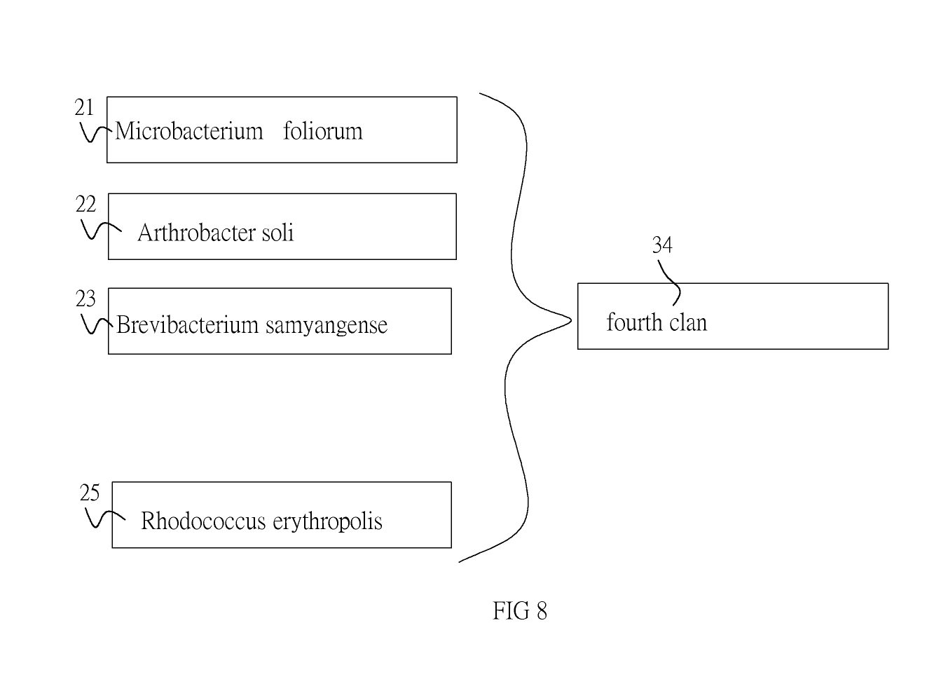

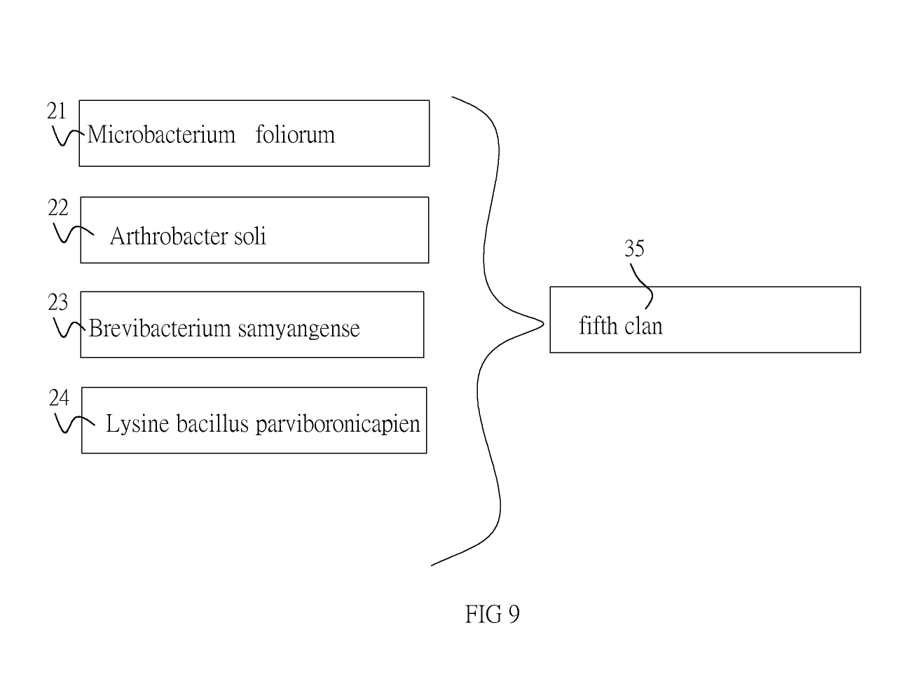

Step of assigning clans 30: the Microbacterium foliorum 21, Arthrobacter soli 22, Brevibacterium samyangense 23, Lysine bacillus parviboronicapien 24 and Rhodococcus erythropolis 25 are respectively identified by corresponding DNA sequence alignment and assigned to several clans 30. With reference to FIG. 5, the identified Microbacterium foliorum 21, Arthrobacter soli 22, Brevibacterium samyangense 23, Lysine bacillus parviboronicapien 24 and Rhodococcus erythropolis 25 are assigned to a first clan 31 when the containing ratio thereamong is 6 to 8 to 1 to 3 to 2, 8 to 8 to 1 to 2 to 1, or 1 to 1 to 1 to 1 to 1. With reference to FIG. 6, the identified Microbacterium foliorum 21, Arthrobacter soli 22, Brevibacterium samyangense 23 and Lysine bacillus parviboronicapien 24 are assigned to a second clan 32 when the containing ratio thereamong is 6 to 8 to 1 to 3, 8 to 8 to 1 to 2, or 1 to 1 to 1 to 1. With reference to FIG. 7, the identified Microbacterium foliorum 21, Arthrobacter soli 22, Brevibacterium samyangense 23 and Rhodococcus erythropolis 25 are assigned to a third clan 33 when the containing ratio thereamong is 6 to 8 to 1 to 2, 8 to 8 to 1 to 1, or 1 to 1 to 1 to 1. With reference to FIG. 8, the identified Microbacterium foliorum 21, Arthrobacter soli 22, Lysine bacillus parviboronicapien 24 and Rhodococcus erythropolis 25 are assigned to a fourth clan 34 when the containing ratio thereamong is 6 to 8 to 3 to 2, 8 to 8 to 2 to 1, or 1 to 1 to 1 to 1. With reference to FIG. 9, the identified Microbacterium foliorum 21, Brevibacterium samyangense 23, Lysine bacillus parviboronicapien 24 and Rhodococcus erythropolis 25 are assigned to a fifth clan 35 when the containing ratio thereamong is 6 to 1 to 3 to 2, 8 to 1 to 2 to 1, or 1 to 1 to 1 to 1.

Step of culturing 40: the first, second, third, fourth and fifth clan 31, 32, 33, 34 and 35 are respectively cultured to form more clans according to the unique property thereof.

Step of husking 50: the coffee beans 80 are husked and the coffee kernels 81 are exploded.

Step of mixing 60: a corresponding one of the cultured clans 31/32/33/34/35 is selected and sprinkled to the coffee kernels 81 according to the thickness and the density of the coffee kernels 81.

Step of fermenting 70: the coffee kernels 81 coated with selected clan 31/32/33/34/35 are peripherally formed a clan coating 82 such that the coffee kernels 81 are transformed to civet coffee beans after being fermented.

With reference to FIGS. 3 to 9, the civet coffee beans are produced step by step according to the method in accordance with the present invention containing the steps of sampling step 10, separating step 20, assigning clans step 30, culturing step 40, husking step 50, mixing step 60 and fermenting step 70, wherein the clan coating 82 on the coffee kernels 81 contains the components selected from the group consisted of Microbacterium foliorum 21, Arthrobacter soli 22, Brevibacterium samyangense 23, Lysine bacillus parviboronicapien 24 and Rhodococcus erythropolis 25.

The coffee beans produced by the method in accordance with the present invention after being ground and reconstituted, the Microbacterium foliorum 21, Arthrobacter soli 22, Brevibacterium samyangense 23, Lysine bacillus parviboronicapien 24 and Rhodococcus erythropolis 25 can reduced the caffeine contained in the coffee is reduced and the harmful strains in the conventional civet coffee is disappeared. In addition, the life of the civet cats is continued.

Furthermore, the selected cultured clan 31/32/33/34/35 is sprinkled to the coffee kernels 81 according to the thickness and the density of the coffee kernels 81 such that all the coffee kernels 81 are equally fermented. As a result, the coffee beans produced by the method accordance with the present invention have an unchangeable texture and aroma after being baked.

Although the invention has been explained in relation to its preferred embodiment, it is to be understood that many other possible modifications and variations can be made without departing from the spirit and scope of the invention as hereinafter claimed.

What is claimed is:

1. A producing method of civet coffee beans comprising the following steps:
step of sampling: the excrements from civet cats is sampled and collected in a vessel;
step of separating: the excrements in the vessel are separated for gaining probiotics, such as Microbacterium foliorum, Arthrobacter soli, Brevibacterium samyangense, Lysine bacillus parviboronicapien and Rhodococcus erythropolis;
step of assigning clans: the Microbacterium foliorum, Arthrobacter soli, Brevibacterium samyangense, Lysine bacillus parviboronicapien and Rhodococcus erythropolis are respectively identified by corresponding DNA sequence alignment and assigned to several clans;
step of culturing: the clans are respectively cultured to form more clans according to the unique property thereof;
step of husking: the coffee beans are husked and the coffee kernels are exploded;
step of mixing: a corresponding one of the cultured clans is selected and sprinkled to the coffee kernels according to the thickness and the density of the coffee kernels; and
step of fermenting: the coffee kernels coated with the selected clan are peripherally formed a clan coating such that the coffee kernels are transformed to civet coffee beans after being fermented.

2. The producing method as claimed in claim 1, wherein the identified Microbacterium foliorum, Arthrobacter soli, Brevibacterium samyangense, Lysine bacillus parviboronicapien and Rhodococcus erythropolis are assigned to a first clan when the containing ratio thereamong is 6 to 8 to 1 to 3 to 2, 8 to 8 to 1 to 2 to 1, or 1 to 1 to 1 to 1 to 1.

3. The producing method as claimed in claim 1, wherein the identified Microbacterium foliorum, Arthrobacter soli, Brevibacterium samyangense and Lysine bacillus parviboronicapien are assigned to a second clan when the containing ratio thereamong is 6 to 8 to 1 to 3, 8 to 8 to 1 to 2, or 1 to 1 to 1 to 1.

4. The producing method as claimed in claim 1, wherein the identified Microbacterium foliorum, Arthrobacter soli, Brevibacterium samyangense and Rhodococcus erythropolis are assigned to a third clan when the containing ratio thereamong is 6 to 8 to 1 to 2, 8 to 8 to 1 to 1, or 1 to 1 to 1 to 1.

5. The producing method as claimed in claim 1, wherein the identified Microbacterium foliorum, Arthrobacter soli, Lysine bacillus parviboronicapien and Rhodococcus erythropolis are assigned to a fourth clan when the containing ratio thereamong is 6 to 8 to 3 to 2, 8 to 8 to 2 to 1, or 1 to 1 to 1 to 1.

6. The producing method as claimed in claim 1, wherein the identified Microbacterium foliorum, Brevibacterium samyangense, Lysine bacillus parviboronicapien and Rhodococcus erythropolis are assigned to a fifth clan when the containing ratio thereamong is 6 to 1 to 3 to 2, 8 to 1 to 2 to 1, or 1 to 1 to 1 to 1.
